(19) United States
(12) Patent Application Publication
(10) Pub. No.: US 2012/0147972 A1
(43) Pub. Date: Jun. 14, 2012

(54) IMAGE DECODING APPARATUS, IMAGE DECODING METHOD, IMAGE ENCODING APPARATUS, IMAGE ENCODING METHOD, AND PROGRAM

(75) Inventor: Masashi MIYAZAKI, Tokyo (JP)

(73) Assignee: Sony Corporation, Tokyo (JP)

(21) Appl. No.: 13/253,176

(22) Filed: Oct. 5, 2011

(30) Foreign Application Priority Data
Dec. 10, 2010 (JP) 2010-275909

(51) Int. Cl. H04N 7/26

(52) U.S. Cl. 375/240.23; 375/E07.033

(57) ABSTRACT

An image decoding apparatus includes a first decoding unit configured to decode a bit stream that is generated by using a first variable length encoding system, so as to generate an intermediate stream, a second decoding unit configured to decode a bit stream that is generated by using a second variable length encoding system, so as to generate a syntax element, a syntax conversion unit configured to convert the syntax element that is generated, from syntax of the second variable length encoding system into syntax of the first variable length encoding system, and a first encoding unit configured to encode the syntax element that is syntax-converted, so as to generate the intermediate stream.

### BACKGROUND

The present technology relates to an image decoding apparatus, an image decoding method, an image encoding apparatus, an image encoding method, and program. Specifically, the present technology facilitates decoding of a plurality of types of bit streams and generation of a plurality of types of bit streams.

In a moving picture encoding system such as a moving picture experts group (MPEG), image data is divided into blocks which are called macroblocks (MB) such as a block of 16 pixels×16 pixels and a block of 8 pixels×8 pixels, and encoding/decoding processing is performed in block units. Further, the encoding/decoding processing is performed in a pipeline operation so as to be speeded up.

In a common pipeline operation, a memory region which can store data of two macroblocks, for example, is secured. The memory region includes a region for one macroblock which is set as a writing region and a region for the other one macroblock which is set as a reading region. The writing region and the reading region are alternately used in a manner being switched per macroblock processing period.

In such pipeline processing in macroblock units, it should be secured that each processing is completed within a certain clock cycle such as several hundred to several thousand cycles. In a case using an encoding system of related art such as MPEG2 and MPEG4, it is sufficiently secured by the present semiconductor technique. However, in an encoding system having a high compression rate such as H.264/advanced video coding (AVC) and VC-1, encoding/decoding processing is complicated. Therefore, it is difficult for the present semiconductor technique to process streams for one frame within a processing period for one frame. For example, concerning variable length decoding, the number of maximum processing cycles has become larger than several hundred or several thousand cycles. Therefore, if an information amount is large in a case using context-based adaptive binary arithmetic coding (CABAC), it is difficult to process streams of one frame within one frame period.

Therefore, in Japanese Unexamined Patent Application Publication No. 2009-17472, data after variable length decoding is temporarily stored in a temporary storage memory, and then the data after the variable length-decoding which is stored in the memory is read out in in-loop decoding processing which is the subsequent stage, thus performing the processing. Thus, if data after the variable length decoding is temporarily stored in the temporary storage memory, fluctuation of a processing cycle per frame or macroblock in the variable length decoding can be absorbed. Further, in a case where data which is completely variable-length-decoded is stored in the temporary storage memory, enormous memory capacity should be secured. Therefore, in Japanese Unexamined Patent Application Publication No. 2009-17472, variable length decoding is performed by a system corresponding to a bit stream and obtained pixel coefficient information is re-encoded by a system different from the encoding system of a plurality of types of bit streams so as to store the re-encoded information in a memory as an intermediate stream. Thus, the intermediate stream is stored in the memory, being able to reduce demanded memory capacity.

### SUMMARY

Meanwhile, in a case where pixel coefficient information is re-encoded by a system different from the encoding system of a plurality of types of bit streams and stored in a memory, separate re-encoding unit and decoding unit for decoding the re-encoded information should be provided, increasing a circuit size. Further, pixel coefficient information is the only re-encoding object and other types of information are not re-encoded. Therefore, capacity of a memory used for temporarily storing an intermediate stream is disadvantageously increased compared to a case where all types of information obtained by performing variable length decoding by a system corresponding to bit streams are re-encoded.

It is desirable to provide an image decoding apparatus, an image decoding method, an image encoding apparatus, an image encoding method, and a program by which encoding and generation of a plurality of types of bit streams can be easily performed.

According to an embodiment of the present technology, there is provided an image decoding apparatus including a first decoding unit configured to decode a bit stream that is generated by using a first variable length encoding system, so as to generate an intermediate stream, a second decoding unit configured to decode a bit stream that is generated by using a second variable length encoding system, so as to generate a syntax element, a syntax conversion unit configured to convert the syntax element that is generated, from syntax of the second variable length encoding system into syntax of the first variable length encoding system, and a first encoding unit configured to encode the syntax element that is syntax-converted, so as to generate the intermediate stream.

In the embodiment of the present technology, CABAC arithmetic decoding is performed with respect to a bit stream of the first variable length encoding system, for example, a bit stream of CABAC so as to generate binary code data which is an intermediate stream. Further, a bit stream of the second variable length encoding system, for example, a bit stream of CAVLC is decoded so as to generate a syntax element. The generated syntax element is converted from syntax of the second variable length encoding system into syntax of the first variable length encoding system and binary code data which is an intermediate stream is generated by binary encoding of the syntax element which is syntax-converted. The intermediate stream is stored in an intermediate stream buffer. Further, binary encoding of the intermediate stream which is stored is performed and the syntax element is supplied to the in-loop decoding unit so as to generate decoded image data.

According to another embodiment of the present technology, there is provided an image decoding method including decoding a bit stream that is generated by using a first variable length encoding system, so as to generate an intermediate stream, decoding a bit stream that is generated by using a second variable length encoding system, so as to generate a syntax element, converting the syntax element from syntax of the second variable length encoding system into syntax of the first variable length encoding system, and encoding the syntax element that is syntax-converted, so as to generate the intermediate stream.

According to still another embodiment of the present technology, there is provided a program that makes a computer execute procedure of decoding a bit stream that is generated by using a first variable length encoding system, so as to generate an intermediate stream, decoding a bit stream that is generated by using a second variable length encoding system, so as to generate a syntax element, converting the syntax element from syntax of the second variable length encoding system into syntax of the first variable length encoding system, and encoding the syntax element that is syntax-converted, so as to generate the intermediate stream.

According to yet another embodiment of the present technology, there is provided an image encoding apparatus including a first encoding unit configured to encode an intermediate stream, which is generated by encoding a syntax element and is stored in an intermediate stream buffer, by using a first variable length encoding system so as to generate a bit stream, a first decoding unit configured to decode the intermediate stream that is stored, so as to generate a syntax element, a syntax conversion unit configured to convert the syntax element that is generated by decoding the intermediate stream from syntax of the first variable length encoding system into syntax of a second variable length encoding system, and a second encoding unit configured to encode the syntax element that is syntax-converted, by using the second variable length encoding system, so as to generate a bit stream.

In this embodiment of the present technology, the intermediate stream which is generated by encoding a syntax element and is stored in the buffer is encoded, for example, arithmetic encoding of the binary code data which is generated by performing binary encoding of the syntax element is performed, generating a bit stream of CABAC which is the first variable length encoding system. Further, a syntax element is generated by decoding the intermediate stream. The syntax element which is generated is converted from syntax of the first variable length encoding system into syntax of the second variable length encoding system and a bit stream of CAVLC which is the second variable length encoding system is generated by encoding the syntax element which is syntax-converted.

According to yet another embodiment of the present technology, there is provided an image encoding method including encoding an intermediate stream, which is generated by encoding a syntax element and is stored in an intermediate stream buffer, by using a first variable length encoding system so as to generate a bit stream, decoding the intermediate stream that is stored, so as to generate a syntax element, converting the syntax element that is generated by decoding the intermediate stream from syntax of the first variable length encoding system into syntax of a second variable length encoding system, and encoding the syntax element that is syntax-converted, by using the second variable length encoding system, so as to generate a bit stream.

According to yet another embodiment of the present technology, there is provided a program that makes a computer execute procedure of encoding an intermediate stream, which is generated by encoding a syntax element and being stored in an intermediate stream buffer, by using a first variable length encoding system so as to generate a bit stream, decoding the intermediate stream that is stored, so as to generate a syntax element, converting the syntax element that is generated by decoding the intermediate stream from syntax of the first variable length encoding system into syntax of a second variable length encoding system, and encoding the syntax element that is syntax-converted, by using the second variable length encoding system, so as to generate a bit stream.

The program of the embodiment of the present technology can be provided to a general-purpose computer system which can execute various program codes, for example, by a storage medium such as an optical disc, a magnetic disc, and a semiconductor memory or a communication medium such as a network, in a computer-readable manner. By providing such program in a computer-readable manner, processing corresponding to the program is realized on a computer system.

According to the embodiments of the present technology, in a case decoding a bit stream, a bit stream generated by using the first variable length encoding system is decoded so as to generate an intermediate stream. Further, the bit stream of the second variable encoding system is decoded so as to generate a syntax element and the syntax element which is generated is converted from syntax of the second variable length encoding system into syntax of the first variable length encoding system. Furthermore, the syntax element which is syntax-converted is encoded so as to generate an intermediate stream.

In a case generating a bit stream, an intermediate stream which is generated by encoding a syntax element and is stored in the intermediate stream buffer is encoded by using the first variable length encoding system so as to generate a bit stream. Further, the syntax element which is generated by decoding the intermediate stream which is stored is converted from the syntax of the first variable length encoding system into the syntax of the second variable length encoding system. Furthermore, the syntax element which is syntax-converted is encoded by using the second variable length encoding system so as to generate a bit stream.

Thanks to such decoding and generation of a bit stream, a re-encoding unit or the like which performs re-encoding by a system different from an encoding system of a plurality of types of bit streams does not have to be provided, being able to suppress increase of a circuit size small. Further, by generating such intermediate stream, necessary capacity of the buffer can be reduced. Furthermore, in a case performing image decoding and image encoding, a circuit which performs encoding and decoding is shared, being able to further suppress the increase of the circuit size small. Accordingly, decoding of a plurality of types of bit streams and generation of a plurality of types of bit streams can be easily performed.

### BRIEF DESCRIPTION OF THE DRAWINGS

FIG. 1 illustrates a configuration example of an image decoding apparatus;

FIG. 2 is a flowchart showing an operation of the image decoding apparatus;

FIG. 3 illustrates a syntax code of a conversion object;

FIG. 4 illustrates a configuration example of an image encoding apparatus; and

FIG. 5 is a flowchart showing an operation of the image encoding apparatus.

### DETAILED DESCRIPTION OF EMBODIMENTS

An embodiment of the present technology will be described below. The description is given in the following order.

### 1. Configuration of Image Decoding Apparatus

### 2. Operation of Image Decoding Apparatus

### 3. Configuration of Image Encoding Apparatus

### 4. Operation of Image Encoding Apparatus

### 5. Case of Software Processing

### <1. Configuration of Image Decoding Apparatus >

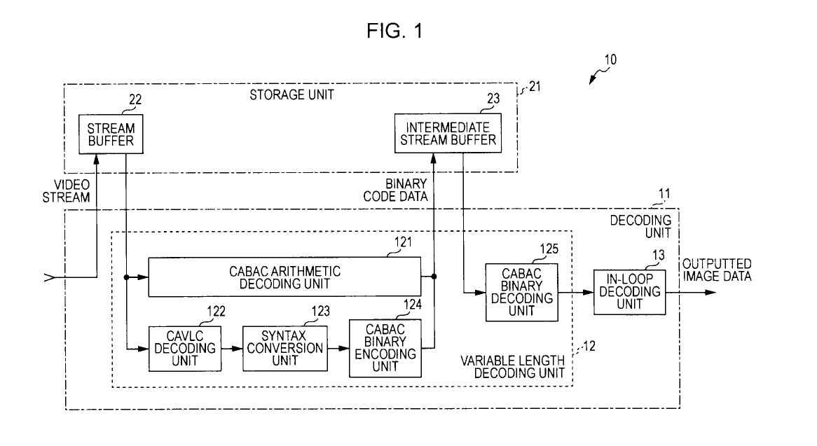

FIG. 1 illustrates a configuration example of an image decoding apparatus according to the embodiment of the present technology. Here, as the configuration example of the image decoding apparatus, a case decoding a bit stream generated by using context-based adaptive binary arithmetic coding (CABAC) as a first variable length encoding system and a bit stream generated by using context-based adaptive variable length coding (CAVLC) as a second variable length encoding system is shown.

An image decoding apparatus 10 is composed of a decoding unit 11 that performs decoding processing of a bit stream and outputs decoded image data and a storage unit 21 that stores the stream. The decoding unit 11 includes a variable length decoding unit 12 and an in-loop decoding unit 13. The variable length decoding unit 12 includes a CABAC arithmetic decoding unit 121, a CAVLC decoding unit 122, a syntax conversion unit 123, a CABAC binary encoding unit 124, and a CABAC binary decoding unit 125. The storage unit 21 is composed of a stream buffer 22 and an intermediate stream buffer 23. FIG. 1 shows the configuration in which the decoding unit 11 and the storage unit 21 are independently provided, but such configuration that the decoding unit 11 includes the storage unit 21 may be employed.

A bit stream (video stream) inputted into the image decoding apparatus 10 is temporarily stored in the stream buffer 22 of the storage unit 21 and then read out from the stream buffer 22 by the decoding unit 11.

The decoding unit 11 decodes the bit stream read out from the stream buffer 22, by the CAVLC decoding unit 122 or the CABAC arithmetic decoding unit 121 in accordance with an encoding system applied to the bit stream which is read out. Specifically, when header information of the bit stream expresses the encoding by CABAC, the decoding unit 11 performs variable length decoding by the CABAC arithmetic decoding unit 121 which is a first decoding unit and outputs obtained binary code data to the intermediate stream buffer 23. When the header information expresses the encoding by CAVLC, the decoding unit 11 performs variable length decoding by the CAVLC decoding unit 122 which is a second decoding unit and outputs an obtained syntax element to the syntax conversion unit 123. Here, the syntax element indicates information which is set to be transmitted in accordance with syntax (expression regulation of data columns) such as quantization data of an orthogonal transformation coefficient and motion vector information.

The syntax conversion unit 123 converts the syntax element outputted from the CAVLC decoding unit 122 from the syntax of CAVLC into syntax of CABAC and outputs the converted syntax element to the CABAC binary encoding unit 124 which is a first encoding unit.

The CABAC binary encoding unit 124 performs binary encoding of the syntax element and outputs obtained binary code data to the intermediate stream buffer 23.

The binary code data which is temporarily stored in the intermediate stream buffer 23 of the storage unit 21 is read out by the CABAC binary decoding unit 125 which is a third decoding unit.

The CABAC binary decoding unit 125 performs decoding processing of the binary code data which is read out from the intermediate stream buffer 23 and outputs an obtained syntax element to the in-loop decoding unit 13.

The in-loop decoding unit 13 performs inverse quantization and inverse orthogonal transformation of the syntax element supplied from the CABAC binary decoding unit 125, inter-frame prediction, intra-frame prediction, and the like so as to generate and output decoded image data.

### <2. Operation of Image Decoding Apparatus>

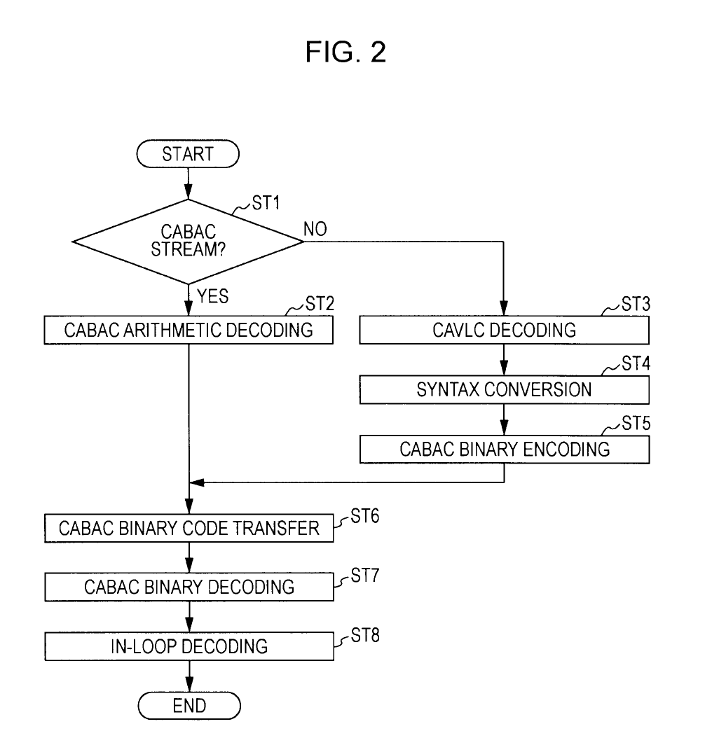

An operation of the image decoding apparatus 10 is now described with reference to a flowchart of FIG. 2. The image decoding apparatus 10 determines whether a bit stream is a CABAC stream in step ST1. The image decoding apparatus 10 goes to step ST2 when the bit stream is the CABAC stream, and the image decoding apparatus 10 goes to step ST3 when the bit stream is a CAVLC stream. The image decoding apparatus 10 determines whether the bit stream is the CABAC stream based on an “entropy_coding_mode_flag” which expresses a mode of an entropy code in a picture parameter set of the bit stream. In the “entropy_coding_mode_flag”, the value of a flag is set to 0 in the case of CAVLC, and the value of the flag is set to 1 in the case of CABAC. Accordingly, when the “entropy_coding_mode_flag” is 1, the image decoding apparatus 10 determines that the bit stream is the CABAC stream and performs processing of step ST2. When the “entropy_coding_mode_flag” is 0, the image decoding apparatus 10 determines that the bit stream is the CAVLC stream and performs processing of step ST3.

The image decoding apparatus 10 performs CABAC arithmetic decoding in step ST2. The CABAC arithmetic decoding unit 121 of the image decoding apparatus 10 performs arithmetic decoding with respect to the bit stream so as to generate binary code data. Then, the operation goes to step ST6.

The image decoding apparatus 10 performs the CAVLC decoding in step ST3. The CAVLC decoding unit 122 of the image decoding apparatus 10 performs CAVLC decoding with respect to the bit stream so as to generate a syntax element. Then, the operation goes to step ST4.

The image decoding apparatus 10 performs syntax conversion in step ST4. The syntax conversion unit 123 of the image decoding apparatus 10 converts syntax of CAVLC into syntax of CABAC for different syntax between CAVLC and CABAC. Then, the operation goes to step ST5.

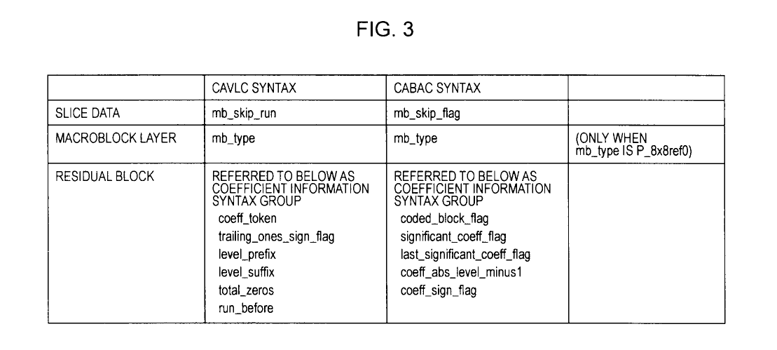

FIG. 3 illustrates a syntax code of a conversion object. In the syntax conversion, the syntax conversion unit 123 deletes “mb_skip_run” of slice data and provides “mb_skip_flag”. Further, a type of P_{—}8×8ref0 is set only in “mb_type” of CAVLC in a macroblock layer, so that the syntax conversion unit 123 changes “mb_type” when “mb_type” is the P_{—}8×8ref0 type. Furthermore, concerning a residual block, a coefficient information syntax group including “coeff_token”, “trailing_ones_sign_flag”, “level_prefix”, “level_suffix”, “total_zeros”, and “run_before” is provided in CAVLC. Accordingly, the syntax conversion unit 123 deletes the coefficient information syntax group of CAVLC. Further, the syntax conversion unit 123 provides a coefficient information syntax group of CABAC, namely, “coded_block_flag”, “significant_coeff_flag”, “last_significant_coeff_flag”, “coeff_abs_level_minus1”, and “coeff_sign_flag”.

The image decoding apparatus 10 performs CABAC binary encoding in step ST5. The CABAC binary encoding unit 124 of the image decoding apparatus 10 performs binary encoding of the syntax element obtained by performing processing of step ST3 and step ST4 so as to generate binary code data. Then, the operation goes to step ST6.

The image decoding apparatus 10 performs CABAC binary code transfer in step ST6. The image decoding apparatus 10 stores the binary code data generated by performing the CABAC arithmetic decoding of step ST2 and the CABAC binary encoding of step ST5 in the intermediate stream buffer 23 of the storage unit 21. Then, the operation goes to step ST7.

The image decoding apparatus 10 performs CABAC binary decoding in step ST7. The CABAC binary decoding unit 125 of the image decoding apparatus 10 reads out the binary code data from the intermediate stream buffer 23 of the storage unit 21 and performs binary decoding so as to generate a syntax element. Then, the operation goes to step ST8.

The image decoding apparatus 10 performs in-loop decoding in step ST8. The in-loop decoding unit 13 of the image decoding apparatus 10 performs inverse quantization and inverse orthogonal transformation of the syntax element supplied from the CABAC binary decoding unit 125, inter-frame prediction, intra-frame prediction, and the like so as to generate decoded image data.

Thus, the image decoding apparatus 10 uses binary code data generated in the CABAC decoding as an intermediate stream. Therefore, it is not necessary to provide a re-encoding unit for generating an intermediate stream when the bit stream is the CABAC stream. Further, when the bit stream is the CAVLC stream, the syntax conversion unit 123 and the CABAC binary encoding unit 124 should be used as a re-encoding unit for generating an intermediate stream. However, in an apparatus which performs not only decoding of an image but also encoding of an image, a CABAC binary encoding unit is used when a CABAC stream is generated. That is, if the CABAC binary encoding unit used for encoding an image is used for generating an intermediate stream, the CABAC binary encoding unit does not have to be provided for generation of an intermediate stream. Accordingly, the simpler configuration can be employed compared to a case of related art in which re-encoding is performed by a system different from an encoding system of a plurality of types of bit streams so as to generate an intermediate stream and store the intermediate stream in a memory. Further, data stored in the intermediate stream buffer 23 is binary code data. Accordingly, memory capacity of the storage unit 21 can be reduced compared to a case where a syntax element which is not re-encoded is stored.

### <3. Configuration of Image Encoding Apparatus>

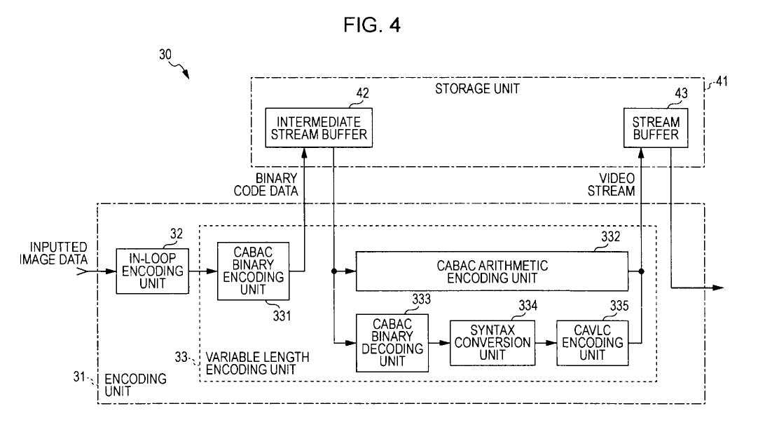

An image encoding apparatus is now described. FIG. 4 illustrates a configuration example of an image encoding apparatus according to the embodiment of the present technology. Here, as the configuration example of the image encoding apparatus, a case generating a bit stream by using context-based adaptive binary arithmetic coding (CABAC) as a first variable length encoding system or context-based adaptive variable length coding (CAVLC) as a second variable length encoding system is shown.

An image encoding apparatus 30 is composed of an encoding unit 31 that performs encoding processing of image data and outputs a bit stream and a storage unit 41 that stores the stream. The encoding unit 31 includes an in-loop encoding unit 32 and a variable length encoding unit 33. The variable length encoding unit 33 includes a CABAC binary encoding unit 331, a CABAC arithmetic encoding unit 332, a CABAC binary decoding unit 333, a syntax conversion unit 334, and a CAVLC encoding unit 335. The storage unit 41 is composed of an intermediate stream buffer 42 and a stream buffer 43. FIG. 4 shows the configuration in which the encoding unit 31 and the storage unit 41 are independently provided, but such configuration that the encoding unit 31 includes the storage unit 41 may be employed.

Image data of an input image inputted into the image encoding apparatus 30 is supplied to the in-loop encoding unit 32. The in-loop encoding unit 32 performs encoding processing of the image data of the input image so as to generate a syntax element. The in-loop encoding unit 32 performs orthogonal transformation of prediction error data expressing an error between an input image and a prediction image, quantization of an orthogonal transformation coefficient, generation of a prediction image by inter-frame prediction or intra-frame prediction, and the like, for example, so as to generate a syntax element. The in-loop encoding unit 32 outputs the syntax element generated by performing the encoding processing to the CABAC binary encoding unit 331 of the variable length encoding unit 33.

The CABAC binary encoding unit 331 which is a third encoding unit performs binary encoding with respect to the syntax element and outputs obtained binary code data to the intermediate stream buffer 42 of the storage unit 41. This binary code data is temporarily stored in the intermediate stream buffer 42 and then read out from the intermediate stream buffer 42 by the variable length encoding unit 33.

The variable length encoding unit 33 encodes the binary code data read out from the intermediate stream buffer 42 by a selected variable length encoding system. For example, in a case where CABAC is selected as the variable length encoding system, the variable length encoding unit 33 performs variable length encoding by the CABAC arithmetic encoding unit 332 which is a first encoding unit and outputs an obtained bit stream to the stream buffer 43. Further, in a case where CAVLC is selected as the variable length encoding system, the variable length encoding unit 33 performs variable length decoding by the CABAC binary decoding unit 333 which is a first decoding unit and outputs an obtained syntax element to the syntax conversion unit 334.

The syntax conversion unit 334 converts the syntax element outputted from the CABAC binary decoding unit 333 from syntax of CABAC to syntax of CAVLC and outputs a converted syntax element to the CAVLC encoding unit 335 which is a second encoding unit.

The CAVLC encoding unit 335 performs variable length encoding of the syntax element of CAVLC and outputs an obtained bit stream to the stream buffer 43.

The bit stream temporarily stored in the stream buffer 43 of the storage unit 41 is read out to be outputted by a predetermined transmission rate.

### <4. Operation of Image Encoding Apparatus>

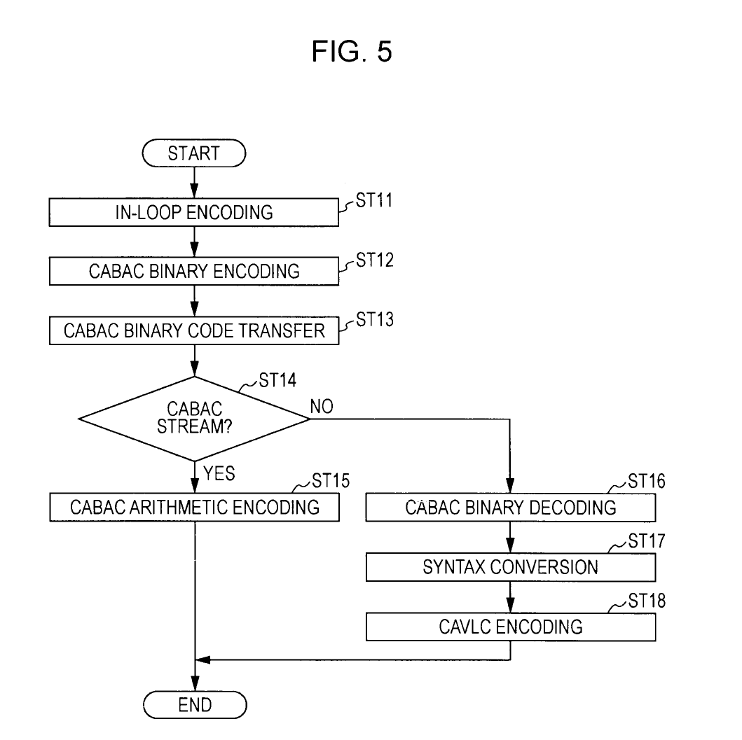

An operation of the image encoding apparatus 30 is now described with reference to a flowchart of FIG. 5. The image encoding apparatus 30 performs in-loop encoding in step ST11. The in-loop encoding unit 32 of the image encoding apparatus 30 performs orthogonal transformation of prediction error data expressing an error between an input image and a prediction image, quantization of an orthogonal transformation coefficient, generation of a prediction image by inter-frame prediction or intra-frame prediction, and the like, for example, so as to generate a syntax element. Then, the operation goes to step ST12.

The image encoding apparatus 30 performs CABAC binary encoding in step ST12. The CABAC binary encoding unit 331 of the image encoding apparatus 30 performs binary encoding of the syntax element generated in step ST11 so as to generate binary code data. Then, the operation goes to step ST13.

The image encoding apparatus 30 performs CABAC binary code transfer in step ST13. The image encoding apparatus 30 stores the binary code data, which is generated by the CABAC binary encoding in step ST12, in the intermediate stream buffer 42 of the storage unit 41. Then, the operation goes to step ST14.

The image encoding apparatus 30 determines whether to be generation of a CABAC stream in step ST14. The image encoding apparatus 30 goes to step ST15 when the variable length encoding system selected by a user or the like is CABAC and the image encoding apparatus 30 goes to step ST16 when the variable length encoding system is CAVLC.

The image encoding apparatus 30 performs CABAC arithmetic encoding in step ST15. The CABAC arithmetic encoding unit 332 of the image encoding apparatus 30 reads out the binary code data stored in the intermediate stream buffer 42 and performs arithmetic encoding so as to generate a bit stream of CABAC.

The image encoding apparatus 30 performs CABAC binary decoding in step ST16. The CABAC binary decoding unit 333 of the image encoding apparatus 30 reads out the binary code data stored in the intermediate stream buffer 42 and performs decoding so as to generate a syntax element. Then, the operation goes to step ST17.

The image encoding apparatus 30 performs syntax conversion in step ST17. The syntax conversion unit 334 of the image encoding apparatus 30 converts syntax of CABAC into syntax of CAVLC for different syntax between CAVLC and CABAC shown in FIG. 3. Then, the operation goes to step ST18.

The image encoding apparatus 30 performs CAVLC encoding in step ST18. The CAVLC encoding unit 335 of the image encoding apparatus 30 performs CAVLC encoding of the syntax element which is obtained by performing processing of step ST16 and step ST17, so as to generate a bit stream of CAVLC.

Thus, the image encoding apparatus 30 uses binary code data generated in CABAC encoding as an intermediate stream. Therefore, it is not necessary to provide an encoding unit for generating an intermediate stream when a bit stream of CABAC is generated. When a bit stream of CAVLC is generated, the CABAC binary decoding unit 333 and the syntax conversion unit 334 should be used because an intermediate stream is binary code data of CABAC. However, in an apparatus performing not only encoding of an image but also decoding of an image, a CABAC binary decoding unit is provided so as to decode a CABAC stream, and an intermediate stream can be decoded by using this CABAC binary decoding unit. Accordingly, the simpler configuration can be employed compared to a case of related art in which an intermediate stream is generated by a system different from an encoding system of a plurality of types of bit streams and stored in a memory. Further, data stored in the intermediate stream buffer 42 is binary code data obtained by performing binary encoding. Accordingly, memory capacity of the storage unit 41 can be reduced compared to a case where a syntax element which is not encoded is stored.

### <5. Case of Software Processing>

A series of processing described in this specification can be executed by hardware, software, or the combined configuration of hardware and software. In a case where processing is executed by software, a program in which processing sequence is recorded is installed into a memory of a computer incorporated in dedicated hardware so as to execute the processing. Alternatively, the processing can be executed by installing the program into a general-purpose computer capable of performing various processing.

For example, the program can be preliminarily recorded in a recording medium such as hard disk and read only memory (ROM). Alternatively, the program can be temporarily or permanently stored (recorded) in a removable recording medium such as a flexible disc, a compact disc read only memory (CD-ROM), a magneto optical (MO) disc, a digital versatile disc (DVD), a magnetic disc, and a semiconductor memory. Such removable recording medium can be provided as so-called packaged software.

Other than installing the program into a computer from the removable recording medium mentioned above, the program can be installed into a recording medium such as internal hard disk and the like such that the computer receives transferred program which is wirelessly transferred from a download site to the computer or transferred to the computer in a wired manner via network such as local area network (LAN) and internet.

The computer reads out and executes the program for executing the series of processing described above and performs encoding processing and decoding processing of a bit stream of image data which is stored in a recording medium, and encoding processing and decoding processing of a bit stream of image data which is supplied via a communication unit.

It should be noted that embodiments of the present technology should not interpreted limitedly to the above described embodiment. For example, the first variable length encoding system is not limited to CABAC but may be other systems as long as intermediate data is generated when a bit stream is decoded so as to generate a syntax element or when a syntax element is encoded so as to generate a bit stream. Here, the intermediate data in this case is used as an intermediate stream. Further, the second variable length encoding system is not limited to CAVLC but may be other systems. It should be noted that the embodiment of the present technology discloses the present technology by exemplification and it is apparent that those skilled in the art can modify and substitute the embodiment within a scope of the present technology. That is, the substance of the present technology should be judged according to the embodiment of the present technology.

The present disclosure contains subject matter related to that disclosed in Japanese Priority Patent Application JP 2010-275909 filed in the Japan Patent Office on Dec. 10, 2010, the entire contents of which are hereby incorporated by reference.

What is claimed is:

1. An image decoding apparatus, comprising:
a first decoding unit configured to decode a bit stream that is generated by using a first variable length encoding system, so as to generate an intermediate stream;
a second decoding unit configured to decode a bit stream that is generated by using a second variable length encoding system, so as to generate a syntax element;
a syntax conversion unit configured to convert the syntax element that is generated, from syntax of the second variable length encoding system into syntax of the first variable length encoding system; and
a first encoding unit configured to encode the syntax element that is syntax-converted, so as to generate the intermediate stream.

2. The image decoding apparatus according to claim 1, further comprising:
an intermediate stream buffer configured to store the intermediate stream; and
a third decoding unit configured to decode the intermediate stream that is stored, so as to generate a syntax element.

3. The image decoding apparatus according to claim 2, wherein
the first variable length encoding system is context-based adaptive binary arithmetic coding that is called CABAC, the first decoding unit performs arithmetic decoding of the bit stream so as to generate binary code data as the intermediate stream,
the syntax conversion unit converts the syntax element that is generated from syntax of the second variable length encoding system into syntax of CABAC,
the first encoding unit performs binary encoding of the syntax element so as to generate binary code data as the intermediate stream, and
the third decoding unit performs binary decoding of the intermediate stream so as to generate a syntax element.

4. The image decoding apparatus according to claim 3, wherein
the second variable length encoding system is context-based adaptive variable length coding that is called CAVLC,
the second decoding unit performs CAVLC decoding of the bit stream so as to generate a syntax element, and
the syntax conversion unit converts the syntax element that is generated from syntax of CAVLC into syntax of CABAC.

5. An image decoding method, comprising:
decoding a bit stream that is generated by using a first variable length encoding system, so as to generate an intermediate stream;
decoding a bit stream that is generated by using a second variable length encoding system, so as to generate a syntax element;
converting the syntax element from syntax of the second variable length encoding system into syntax of the first variable length encoding system; and
encoding the syntax element that is syntax-converted, so as to generate the intermediate stream.

6. A program that makes a computer execute procedure comprising:
decoding a bit stream that is generated by using a first variable length encoding system, so as to generate an intermediate stream;
decoding a bit stream that is generated by using a second variable length encoding system, so as to generate a syntax element;
converting the syntax element from syntax of the second variable length encoding system into syntax of the first variable length encoding system; and
encoding the syntax element that is syntax-converted, so as to generate the intermediate stream.

7. An image encoding apparatus, comprising:
a first encoding unit configured to encode an intermediate stream, the intermediate stream being generated by encoding a syntax element and being stored in an intermediate stream buffer, by using a first variable length encoding system so as to generate a bit stream;
a first decoding unit configured to decode the intermediate stream that is stored, so as to generate a syntax element;
a syntax conversion unit configured to convert the syntax element that is generated by decoding the intermediate stream from syntax of the first variable length encoding system into syntax of a second variable length encoding system; and
a second encoding unit configured to encode the syntax element that is syntax-converted, by using the second variable length encoding system, so as to generate a bit stream.

8. The image encoding apparatus according to claim 7, further comprising:
a third encoding unit configured to encode a syntax element so as to generate the intermediate stream; and
the intermediate stream buffer configured to store the intermediate stream.

9. The image encoding apparatus according to claim 8, wherein
the first variable length encoding system is context-based adaptive binary arithmetic coding that is called CABAC,
the third encoding unit performs binary encoding of a syntax element so as to generate binary code data as the intermediate stream,
the first encoding unit performs arithmetic encoding of the intermediate stream so as to generate a bit stream,
the first decoding unit performs binary decoding of the intermediate stream so as to generate a syntax element, and
the syntax conversion unit converts the syntax element that is generated by the first decoding unit from syntax of CABAC into syntax of the second variable length encoding system.

10. The image encoding apparatus according to claim 9, wherein
the second variable length encoding system is context-based adaptive variable length coding that is called CAVLC,
the syntax conversion unit converts the syntax element that is generated by the first decoding unit from syntax of CABAC into syntax of CAVLC, and
the second encoding unit performs CAVLC encoding of the syntax element that is syntax-converted, so as to generate a bit stream.

11. An image encoding method, comprising:
encoding an intermediate stream, the intermediate stream being generated by encoding a syntax element and being stored in an intermediate stream buffer, by using a first variable length encoding system so as to generate a bit stream;
decoding the intermediate stream that is stored, so as to generate a syntax element;
converting the syntax element that is generated by decoding the intermediate stream from syntax of the first variable length encoding system into syntax of a second variable length encoding system; and
encoding the syntax element that is syntax-converted, by using the second variable length encoding system, so as to generate a bit stream.

12. A program that makes a computer execute procedure comprising:
encoding an intermediate stream, the intermediate stream being generated by encoding a syntax element and being stored in an intermediate stream buffer, by using a first variable length encoding system so as to generate a bit stream;
decoding the intermediate stream that is stored, so as to generate a syntax element;
converting the syntax element that is generated by decoding the intermediate stream from syntax of the first variable length encoding system into syntax of a second variable length encoding system; and
encoding the syntax element that is syntax-converted, by using the second variable length encoding system, so as to generate a bit stream.
